(19) United States
(12) Patent Application Publication
(10) Pub. No.: US 2023/0229153 A1
(43) Pub. Date: Jul. 20, 2023

(54) Diagnostic Method, Diagnostic Device, And Diagnostic System

(71) Applicant: SEIKO EPSON CORPORATION, Tokyo (JP)

(72) Inventor: Kenta SATO, Shiojiri (JP)

(21) Appl. No.: 18/155,223

(22) Filed: Jan. 17, 2023

(30) Foreign Application Priority Data
Jan. 18, 2022 (JP) 2022-005536

(51) Int. Cl. G05B 23/02

(52) U.S. Cl. CPC G05B 23/0235; G05B 23/0221

(57) ABSTRACT

A diagnostic method includes: acquiring first measurement data based on a physical quantity generated by an object repeating a predetermined operation pattern in a first period; a reference data generation step of generating reference data based on the first measurement data; acquiring second measurement data based on a physical quantity generated by the object repeating the predetermined operation pattern in a second period; and a diagnosis step of diagnosing a state of the object based on the reference data and the second measurement data, in which the reference data generation step includes extracting, from the first measurement data, a plurality of pieces of first period unit data corresponding to at least a part of the predetermined operation pattern, and generating the reference data by calculating a representative value of the plurality of pieces of first period unit data subjected to synchronization processing.

The present application is based on, and claims priority from JP Application Serial Number 2022-005536, filed Jan. 18, 2022, the disclosure of which is hereby incorporated by reference herein in its entirety.

### BACKGROUND

### 1. Technical Field

The present disclosure relates to a diagnostic method, a diagnostic device, and a diagnostic system.

### 2. Related Art

JP-A-5-52712 discloses a failure prediction device including a vibration detection unit configured to detect a vibration pattern of a moving part generated from a plurality of moving parts constituting a production machine at a free end of the moving part, a storage unit configured to store, during a normal operation of the production machine, a reference vibration pattern at the free end, and a failure prediction unit configured to predict a failure of the production machine by comparing the vibration pattern detected at any time by the vibration detection unit with the reference vibration pattern stored in the storage unit.

JP-A-5-52712 does not disclose a specific method of creating the reference vibration pattern, and when accuracy of the reference vibration pattern is low, reliability of failure prediction decreases.

### SUMMARY

A diagnostic method according to one aspect of the present disclosure includes:

a first measurement data acquisition step of acquiring first measurement data based on a time-series signal obtained by a physical quantity sensor detecting a physical quantity generated by an object repeating a predetermined operation pattern in a first period;

a reference data generation step of generating reference data based on the first measurement data;

a second measurement data acquisition step of acquiring second measurement data based on a time-series signal obtained by the physical quantity sensor detecting a physical quantity generated by the object repeating the predetermined operation pattern in a second period; and

a diagnosis step of diagnosing a state of the object based on the reference data and the second measurement data, in which

the reference data generation step includes

extracting, from the first measurement data, a plurality of pieces of first period unit data corresponding to at least a part of the predetermined operation pattern, and

generating the reference data by executing synchronization processing on the plurality of pieces of first period unit data and calculating a representative value of the plurality of pieces of first period unit data subjected to the synchronization processing.

A diagnostic device according to one aspect of the present disclosure includes:

a first measurement data acquisition circuit configured to acquire first measurement data based on a time-series signal obtained by a physical quantity sensor detecting a physical quantity generated by an object repeating a predetermined operation pattern in a first period;

a reference data generation circuit configured to generate reference data based on the first measurement data;

a second measurement data acquisition circuit configured to acquire second measurement data based on a time-series signal obtained by the physical quantity sensor detecting a physical quantity generated by the object repeating the predetermined operation pattern in a second period; and

a diagnosis circuit configured to diagnose a state of the object based on the reference data and the second measurement data, in which

the reference data generation circuit

extracts, from the first measurement data, a plurality of pieces of first period unit data corresponding to at least a part of the predetermined operation pattern, executes synchronization processing on the plurality of pieces of first period unit data, and calculates a representative value of the plurality of pieces of first period unit data subjected to the synchronization processing to generate the reference data.

A diagnostic system according to one aspect of the present disclosure includes:

the diagnostic device according to the one aspect; and

the physical quantity sensor attached to the object.

### BRIEF DESCRIPTION OF THE DRAWINGS

FIG. 1 is a flowchart showing a procedure of a diagnostic method according to a first embodiment.

FIG. 2 is a flowchart showing an example of a procedure of a reference data generation step.

FIG. 3 is a diagram showing a part of first measurement data according to the first embodiment.

FIG. 4 is a diagram showing synchronization processing according to the first embodiment.

FIG. 5 is a diagram showing the synchronization processing according to the first embodiment.

FIG. 6 is a diagram showing the synchronization processing according to the first embodiment.

FIG. 7 is a diagram showing a waveform of reference data according to the first embodiment.

FIG. 8 is a diagram showing a frequency spectrum obtained by performing fast Fourier transform on the reference data.

FIG. 9 is a flowchart showing an example of a procedure of a diagnosis step.

FIG. 10 is a diagram showing an example of a Lissajous' figure.

FIG. 11 is a diagram showing a configuration example of a diagnostic device.

FIG. 12 is a diagram showing a part of first measurement data according to a second embodiment.

FIG. 13 is a diagram showing synchronization processing according to the second embodiment.

FIG. 14 is a diagram showing synchronization processing according to the second embodiment.

FIG. 15 is a diagram showing a waveform of reference data according to the second embodiment.

FIG. 16 is a flowchart showing an example of a procedure of the diagnosis step in a diagnostic method of a third embodiment.

FIG. 17 is a flowchart showing an example of a procedure of the reference data generation step according to a fourth embodiment.

FIG. 18 is a diagram showing an example of a relationship between the first measurement data and a plurality of pieces of first period unit data corresponding to an i-th operation according to the fourth embodiment.

FIG. 19 is a flowchart showing an example of a procedure of the diagnosis step in the fourth embodiment.

FIG. 20 is a flowchart showing another example of a procedure of the diagnosis step in a diagnostic method of the fourth embodiment.

FIG. 21 is a diagram showing a configuration example of a diagnostic system according to the present embodiment.

### DESCRIPTION OF EXEMPLARY EMBODIMENTS

Hereinafter, preferred embodiments of the present disclosure will be described in detail with reference to the drawings. The embodiments described below do not unduly limit the scope of the present disclosure described in the claims. Not all configurations to be described below are necessarily essential constituent elements of the present disclosure.

### 1. Diagnostic Method and Diagnostic Device

### 1-1. First Embodiment

### 1-1-1. Diagnostic Method

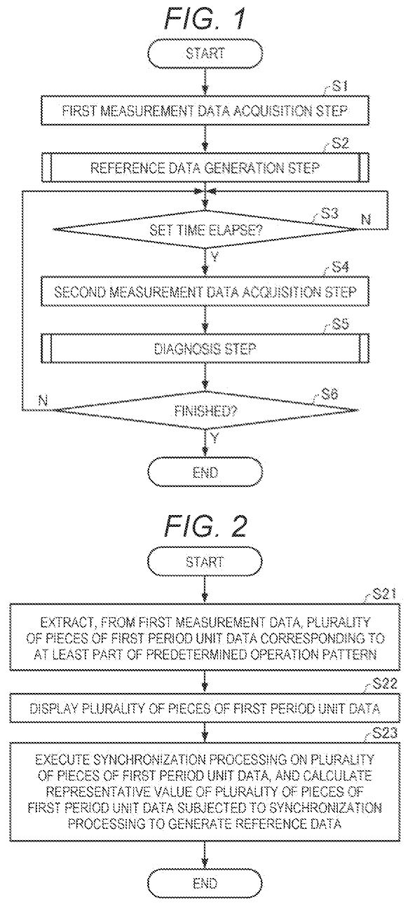

FIG. 1 is a flowchart showing a procedure of a diagnostic method according to a first embodiment. As shown in FIG. 1, the diagnostic method according to the first embodiment includes a first measurement data acquisition step S1, a reference data generation step S2, a second measurement data acquisition step S4, and a diagnosis step S5. The diagnostic method according to the first embodiment is executed by, for example, a diagnostic device 100. A configuration example of the diagnostic device 100 which executes the diagnostic method of the first embodiment will be described later.

As shown in FIG. 1, first, in the first measurement data acquisition step S1, the diagnostic device 100 acquires first measurement data based on a time-series signal obtained by a physical quantity sensor detecting a physical quantity generated by an object repeating a predetermined operation pattern in a first period.

The first period may be, for example, a predetermined period in which the object normally operates, such as a period immediately after the object is disposed.

The object is an object to be diagnosed, and a type of the object is not particularly limited, and may be, for example, various devices such as an electric motor or a motor having a rotation mechanism or a vibration mechanism, or may be an electric circuit generating signals having periodicity.

The predetermined operation pattern repeated by the object in the first period may be a pattern in which the object executes one type of operation and then stops the operation, or may be a pattern in which each time the object executes each of a plurality of different types of operations, the operation is stopped. For example, when the object is a motor, the object may repeatedly execute an operation of rotating clockwise and an operation of stopping the rotation, or may repeatedly execute an operation of rotating clockwise, an operation of stopping the rotation, an operation of rotating counterclockwise, and an operation of stopping the rotation.

A type of physical quantity generated by the object repeating the predetermined operation pattern is not particularly limited, and for example, the physical quantity may be acceleration, an angular velocity, a velocity, displacement, a pressure, a current, or a voltage.

For example, the physical quantity sensor may be an inertial sensor. The inertial sensor is, for example, an acceleration sensor, a velocity sensor, an angular velocity sensor, or an IMU including a plurality of types of sensors. IMU is an abbreviation for inertial measurement unit. The physical quantity sensor may be, for example, a sensor using a MEMS vibrator or a sensor using a crystal resonator. MEMS is an abbreviation for micro electro mechanical systems. The number of detection axes of the physical quantity sensor may be one or more.

The first measurement data may be time-series data of a digital signal output from the physical quantity sensor, or time-series data of a digital signal obtained by an analog front end converting an analog signal output from the physical quantity sensor.

Next, in the reference data generation step S2, the diagnostic device 100 generates reference data based on the first measurement data acquired in step S1.

Next, the diagnostic device 100 waits until a set time elapses in step S3. When the set time elapses, in the second measurement data acquisition step S4, the diagnostic device 100 acquires second measurement data based on a time-series signal obtained by the physical quantity sensor detecting a physical quantity generated by the object repeating the predetermined operation pattern in a second period.

In the present embodiment, the second period is a period after the first period, and is, for example, a predetermined period such as several days after the first period, several months after the first period, or several years after the first period. The predetermined operation pattern repeated by the object in the second period is the same as the predetermined operation pattern repeated by the object in the first period.

The second measurement data may be time-series data of a digital signal output from the physical quantity sensor, or time-series data of a digital signal obtained by an analog front end converting an analog signal output from the physical quantity sensor.

Next, in the diagnosis step S5, the diagnostic device 100 diagnoses a state of the object based on the reference data generated in step S2 and the second measurement data acquired in step S4.

The diagnostic device 100 may diagnose, assuming that the object is in a normal state in the first period, whether the object is in a normal state or in an abnormal state in the second period. The diagnostic device 100 may diagnose how much the object changes with the passage of time from the first period to the second period.

Until the diagnosis is finished (N in step S6), the diagnostic device 100 repeatedly executes steps S3 to S5. The set time for waiting in step S3 may be a fixed value or may be a variable value which is appropriately set every time.

FIG. 2 is a flowchart showing an example of a procedure of the reference data generation step S2 in FIG. 1. As shown in FIG. 2, first, in step S21, the diagnostic device 100 extracts, from the first measurement data acquired in step S1 of FIG. 1, a plurality of pieces of first period unit data corresponding to at least a part of the predetermined operation pattern repeated by the object in the first period. For example, if the predetermined operation pattern is a pattern in which the object executes one type of operation and then stops the operation, the plurality of pieces of first period unit data may be data corresponding to the operation. For example, if the predetermined operation pattern is a pattern in which each time the object executes each of a plurality of different types of operations, the operation is stopped, the plurality of pieces of first period unit data may be data corresponding to the plurality of operations.

Next, in step S22, the diagnostic device 100 displays, on a display unit (not shown), the plurality of pieces of first period unit data extracted in step S21.

Finally, in step S23, the diagnostic device 100 executes synchronization processing on the plurality of pieces of first period unit data extracted in step S21, and calculates a representative value of the plurality of pieces of first period unit data subjected to the synchronization processing to generate reference data. The synchronization processing is processing of aligning timings so that a difference between predetermined data and the other pieces of data in the plurality of pieces of first period unit data is minimized. The representative value is, for example, an average value, or a median value.

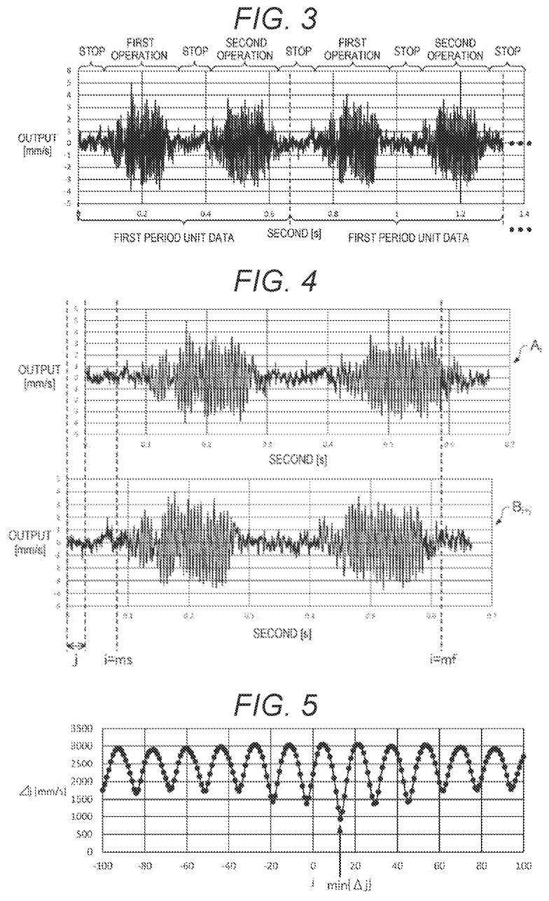

FIG. 3 is a diagram showing a part of the first measurement data acquired in the first measurement data acquisition step S1. The first measurement data shown in FIG. 3 is a part of velocity data based on a time-series signal output from a velocity sensor which is the physical quantity sensor when the motor which is the object repeats a predetermined operation pattern including a first operation, stop, a second operation, and stop in the first period. As shown in FIG. 3, the diagnostic device 100 extracts, in step S21, from the first measurement data, data obtained when the motor executes the first operation, the stop, and the second operation, which are a part of the predetermined operation pattern, at an n-th time, as an n-th first period unit data.

FIGS. 4 to 6 are diagrams showing synchronization processing between first first period unit data in FIG. 3 and second first period unit data with the first first period unit data as the predetermined data in step S23. FIG. 4 is a diagram in which a sample of the second first period unit data is shifted by j with respect to the first first period unit data and is aligned with the first first period unit data. j is defined as −j≤jₘₐₓ. In FIG. 4, when an i-th sample of the first first period unit data is Δⱼ and an i-th sample of the second first period unit data is Bᵢ, the sample Δⱼ and a sample Bᵢ₊ⱼ correspond to each other at the same timing. At this time, a difference Δⱼ between the first first period unit data and the second first period unit data obtained by shifting the sample by j is calculated by Formula (1). In Formula (1), when the number of samples of the first first period unit data and the number of samples of the second first period unit data are M, mₛ≥jₘₐₓ and m_{f}≥M−jₘₐₓ.

$${Δ}_{j} = {\sum }_{i = {m}_{s}}^{{m}_{f}} \vert {A}_{i} - {B}_{i + j} \vert \qquad ( 1 )$$

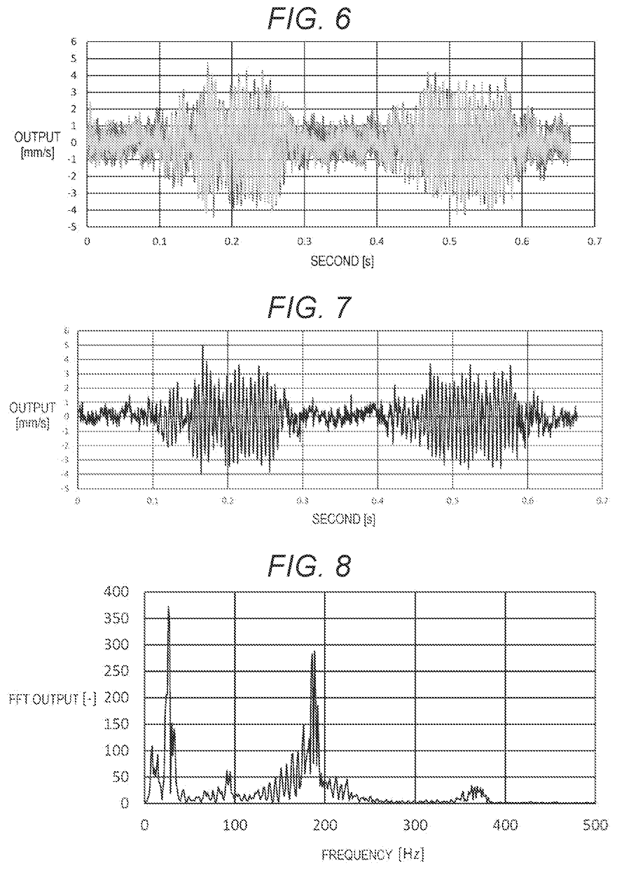

FIG. 5 is a diagram showing a series of differences Δⱼ calculated by Formula (1) for each integer j satisfying −jₘₐₓ≤j≤jₘₐₓ. In an example of FIG. 5, jₘₐₓ=100. The synchronization processing between the first first period unit data and the second first period unit data is processing of aligning the second first period unit data with the first first period unit data by shifting a sample of the second first period unit data by the integer j in which the difference Δⱼ is minimized. The diagnostic device 100 calculates, by Formula (1) with j being set to −jₘₐₓ≤j≤jₘₐₓ, a series of differences Δⱼ between each of the second and subsequent n-th first period unit data and the first first period unit data, and executes synchronization processing of aligning the n-th first period unit data with the first first period unit data by shifting a sample of the n-th first period unit data by the integer j in which the difference Δⱼ is minimized. FIG. 6 is a diagram in which waveforms of a plurality of pieces of first period unit data extracted from the first measurement data and subjected to the synchronization processing are superimposed.

FIG. 7 is a diagram showing a waveform of reference data generated by calculating, as a representative value of a plurality of pieces of first period unit data subjected to the synchronization processing in step S23, an average value of the plurality of pieces of first period unit data. The waveform of the reference data in FIG. 7 is an averaged waveform obtained by averaging the waveforms of the plurality of pieces of first period unit data in FIG. 6. High frequency noise is reduced by averaging the waveforms of the plurality of pieces of first period unit data.

FIG. 8 is a diagram showing a frequency spectrum obtained by performing fast Fourier transform on the reference data of FIG. 7. In the frequency spectrum shown in FIG. 8, clear peaks are generated at specific frequencies due to the reduction of the high frequency noise, and it can be said that the reference data obtained by averaging the plurality of pieces of first period unit data is data truly showing a state of the object in the first period.

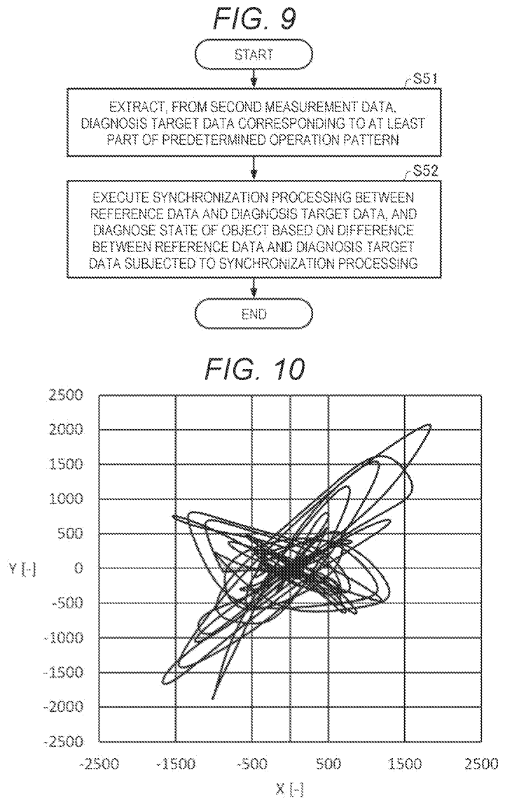

FIG. 9 is a flowchart showing an example of a procedure of the diagnosis step S5 in FIG. 1. As shown in FIG. 9, first, in step S51, the diagnostic device 100 extracts, from the second measurement data acquired in step S4 of FIG. 1, diagnosis target data corresponding to at least a part of a predetermined operation pattern repeated by the object in the second period. Processing of extracting the diagnosis target data from the second measurement data is similar to processing of extracting any first period unit data from the first measurement data in step S21 of FIG. 2. For example, similar as the first period, when the object repeats a predetermined operation pattern including a first operation, stop, a second operation, and stop in the second period, the diagnostic device 100 may extract, from the second measurement data, data obtained when the object executes the first operation, the stop, and the second operation, which are a part of the predetermined operation pattern, at any k-th time, as the diagnosis target data.

In step S52, the diagnostic device 100 executes synchronization processing between the reference data generated in step S2 of FIG. 1 and the diagnosis target data extracted in step S51, and diagnoses a state of the object based on a difference between the reference data and the diagnosis target data subjected to the synchronization processing. The synchronization processing is processing of aligning timings so that the difference between the reference data and the diagnosis target data is minimized. Specifically, when an i-th sample of the reference data is Cᵢ and an i-th sample of the diagnosis target data is Dᵢ, a difference Δⱼ between the reference data and the diagnosis target data obtained by shifting the i-th sample of the diagnosis target data by j is calculated by Formula (2) similar to Formula (1) described above. In Formula (2), when −jₘₐₓ≤j≤jₘₐₓ and the number of samples of the reference data and the number of samples of the diagnosis target data are M, mₛ≥jₘₐₓ and m_{f} M−jₘₐₓ.

$${Δ}_{j} = {\sum }_{i = {m}_{s}}^{{m}_{f}} \vert {C}_{i} - {D}_{i + j} \vert \qquad ( 2 )$$

The diagnostic device 100 calculates, by Formula (2) with j being −jₘₐₓ≤j≤jₘₐₓ, a series of differences Δⱼ between the reference data and the diagnosis target data, executes synchronization processing of aligning the diagnosis target data with the reference data by shifting a sample of the diagnosis target data by the integer j in which the difference Δⱼ is minimized, and obtains a minimum value min{Δⱼ} of the difference Δⱼ. When the minimum value min{Δⱼ} is smaller than a predetermined threshold value, the diagnostic device 100 can diagnose that a difference between a state of the object in the second period and a state of the object in the first period is small, that is, a state change of the object is small. When the minimum value min{Δⱼ} is larger than the predetermined threshold value, the diagnostic device 100 can diagnose that the difference between the state of the object in the second period and the state of the object in the first period is large, that is, the state change of the object is large. When the first period is a predetermined period in which the object normally operates, the diagnostic device 100 can diagnose that the object in the second period is in a normal state when the minimum value min{Δⱼ} is smaller than the predetermined threshold value, and can diagnose that the object in the second period is in an abnormal state when the minimum value min{Δⱼ} is larger than the predetermined threshold value.

In step S23 of FIG. 2, the diagnostic device 100 may diagnose the state of the object in the second period by setting, as a reference value ref{min{Δⱼ}}, a minimum value min{Δⱼ} of the difference between the predetermined data and any one of the other pieces of data in the plurality of pieces of first period unit data, and by comparing, with a predetermined threshold value, a standard value std{min{Δⱼ} } obtained by dividing a minimum value min{Δⱼ} of the difference Δⱼ between the reference data and the diagnosis target data by the reference value ref{min{Δⱼ}}. In this way, even if a magnitude of the minimum value min{Δⱼ} is different depending on characteristics of the object and an installation location of the physical quantity sensor, a magnitude of the standard value std{min{Δⱼ}} hardly changes. Therefore, a constant threshold value can be used for diagnosis regardless of the characteristics of the object and the installation location of the physical quantity sensor. The diagnostic device 100 may calculate, as the reference value ref{min{Δⱼ}}, an average value of minimum values min{Δⱼ} of differences between predetermined data and the other pieces of data in the plurality of pieces of first period unit data.

In step S5 of FIG. 1, the diagnostic device 100 may execute another diagnostic processing together with diagnostic processing shown in FIG. 9 or instead of the diagnostic processing shown in FIG. 9. For example, the diagnostic device 100 may calculate RMS values of the reference data and the diagnosis target data, and compare the difference between the two RMS values with a predetermined threshold value to diagnose the state of the object in the second period. For example, the diagnostic device 100 may calculate two frequency spectra by performing fast Fourier transform on the reference data and the diagnosis target data, and compare a difference between peak frequencies or peak intensities with predetermined threshold values to diagnose the state of the object in the second period. For example, when there are a plurality of detection axes of the physical quantity sensor, the diagnostic device 100 may generate reference data and diagnosis target data for each detection axis, calculate a Lissajous' figure of a plurality of pieces of reference data and a Lissajous' figure of a plurality of pieces of diagnosis target data, and diagnose the state of the object in the second period based on a difference between the two Lissajous' figures. FIG. 10 shows an example of a Lissajous' figure. The example in FIG. 10 is a Lissajous' figure of X-axis data and Y-axis data.

### 1-1-2. Diagnostic Device

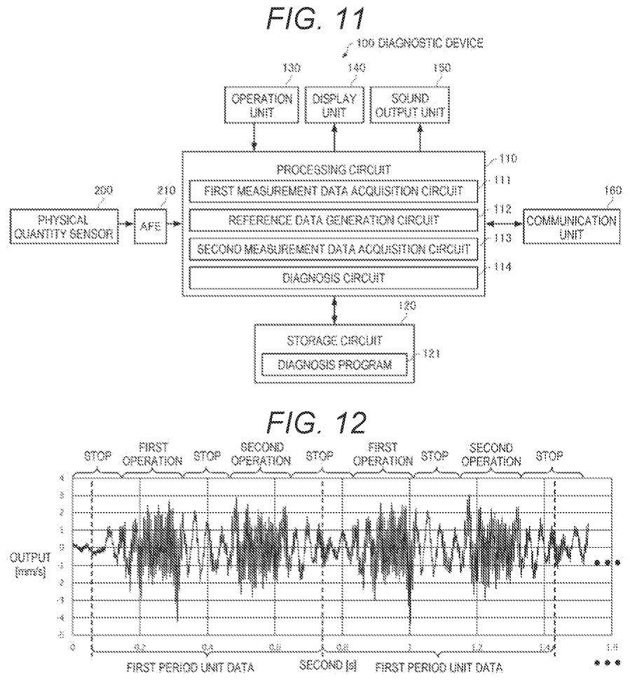

FIG. 11 is a diagram showing a configuration example of the diagnostic device 100 which executes the diagnostic method according to the first embodiment. As shown in FIG. 11, the diagnostic device 100 includes a physical quantity sensor 200, an analog front end 210, a processing circuit 110, a storage circuit 120, an operation unit 130, a display unit 140, a sound output unit 150, and a communication unit 160. In the diagnostic device 100, some of components in FIG. 11 may be omitted or changed, or other components may be added. For example, the physical quantity sensor 200 and the analog front end 210 may not be components of the diagnostic device 100.

The physical quantity sensor 200 detects a physical quantity generated by the object repeating a predetermined operation pattern in the first period and in the second period, and outputs a signal having a magnitude corresponding to the detected physical quantity. An output signal of the physical quantity sensor 200 is input to the analog front end 210.

The analog front end 210 executes amplification processing, A/D conversion processing, and the like on the output signal of the physical quantity sensor 200, and outputs a digital time-series signal.

The processing circuit 110 acquires, as the first measurement data, a digital time-series signal output from the analog front end 210 in the first period, acquires, as the second measurement data, a digital time-series signal output from the analog front end 210 in the second period, and executes signal processing. Specifically, the processing circuit 110 executes a diagnosis program 121 stored in the storage circuit 120, and executes various types of calculation processing on the first measurement data and the second measurement data. In addition, the processing circuit 110 executes various types of processing according to operation signals from the operation unit 130, processing for transmitting display signals for displaying various types of information on the display unit 140, processing for transmitting sound signals for generating various sounds to the sound output unit 150, processing for controlling the communication unit 160 to perform data communication with an external device (not shown), and the like. The processing circuit 110 is implemented by, for example, a CPU or a DSP. The CPU is an abbreviation for central processing unit, and the DSP is an abbreviation for digital signal processor.

The processing circuit 110 functions as, by executing the diagnosis program 121, a first measurement data acquisition circuit 111, a reference data generation circuit 112, a second measurement data acquisition circuit 113, and a diagnosis circuit 114. That is, the diagnostic device 100 includes the first measurement data acquisition circuit 111, the reference data generation circuit 112, the second measurement data acquisition circuit 113, and the diagnosis circuit 114.

The first measurement data acquisition circuit 111 acquires first measurement data based on a time-series signal obtained by the physical quantity sensor 200 detecting a physical quantity generated by an object repeating a predetermined operation pattern in the first period. That is, the first measurement data acquisition circuit 111 acquires, as the first measurement data, a digital time-series signal output from the analog front end 210 in the first period. That is, the first measurement data acquisition circuit 111 executes the first measurement data acquisition step S1 in FIG. 1. The first measurement data acquired by the first measurement data acquisition circuit 111 is stored in the storage circuit 120.

The reference data generation circuit 112 generates reference data based on the first measurement data acquired by the first measurement data acquisition circuit 111. Specifically, the reference data generation circuit 112 extracts, from the first measurement data, a plurality of pieces of first period unit data corresponding to at least a part of the predetermined operation pattern repeated by the object in the first period, executes synchronization processing on the extracted plurality of pieces of first period unit data, and calculates a representative value of the plurality of pieces of first period unit data subjected to the synchronization processing to generate the reference data. The synchronization processing is processing of aligning timings so that a difference between predetermined data and the other pieces of data in the plurality of pieces of first period unit data is minimized. For example, the reference data generation circuit 112 calculates, by the above Formula (1), a series of differences Δⱼ between the predetermined data and the other pieces of data, and executes synchronization processing of aligning the other pieces of data with the predetermined data by shifting samples of the other pieces of data by the integer j in which the difference Δⱼ is minimized. The representative value is, for example, an average value, or a median value. The reference data generation circuit 112 may display, on the display unit 140, the extracted plurality of pieces of first period unit data. That is, the reference data generation circuit 112 executes the reference data generation step S2 in FIG. 1, specifically, steps S21, S22, and S23 in FIG. 2. The reference data generated by the reference data generation circuit 112 is stored in the storage circuit 120.

The second measurement data acquisition circuit 113 acquires the second measurement data based on a time-series signal obtained by the physical quantity sensor 200 detecting the physical quantity generated by the object repeating the predetermined operation pattern in the second period. That is, the second measurement data acquisition circuit 113 acquires, as the second measurement data, a digital time-series signal output from the analog front end 210 in the second period. That is, the second measurement data acquisition circuit 113 executes the second measurement data acquisition step S4 in FIG. 1. The second measurement data acquired by the second measurement data acquisition circuit 113 is stored in the storage circuit 120.

The diagnosis circuit 114 diagnoses the state of the object based on the reference data generated by the reference data generation circuit 112 and the second measurement data acquired by the second measurement data acquisition circuit 113. The diagnosis circuit 114 may diagnose, assuming that the object is in a normal state in the first period, whether the object is in a normal state or in an abnormal state in the second period. The diagnostic device 100 may diagnose how much the object changes with the passage of time from the first period to the second period. For example, the diagnosis circuit 114 may extract, from the second measurement data, diagnosis target data corresponding to at least a part of a predetermined operation pattern repeated by the object in the second period, execute synchronization processing between the reference data and the diagnosis target data, and diagnose the state of the object based on a difference between the reference data and the diagnosis target data subjected to the synchronization processing. The synchronization processing is processing of aligning timings so that the difference between the reference data and the diagnosis target data is minimized.

For example, the diagnosis circuit 114 calculates, by Formula (2) with j being −jₘₐₓ≤j≤jₘₐₓ, a series of differences Δⱼ between the reference data and the diagnosis target data, executes synchronization processing of aligning the diagnosis target data with the reference data by shifting a sample of the diagnosis target data by the integer j in which the difference Δⱼ is minimized, and obtains a minimum value min{Δⱼ} of the difference Δⱼ. When the minimum value min{Δⱼ} is smaller than a predetermined threshold value, the diagnosis circuit 114 can diagnose that a difference between the state of the object in the second period and the state of the object in the first period is small, that is, a state change of the object is small. When the minimum value min{Δⱼ} is larger than the predetermined threshold value, the diagnosis circuit 114 can diagnose that the difference between the state of the object in the second period and the state of the object in the first period is large, that is, the state change of the object is large. When the first period is a predetermined period in which the object normally operates, the diagnosis circuit 114 can diagnose that the object in the second period is in a normal state when the minimum value min{Δⱼ} is smaller than the predetermined threshold value, and can diagnose that the object in the second period is in an abnormal state when the minimum value min{Δⱼ} is larger than the predetermined threshold value. That is, the diagnosis circuit 114 executes the diagnosis step S5 in FIG. 1, specifically, steps S51 and S52 in FIG. 9. Diagnosis result information of the diagnosis circuit 114 is stored in the storage circuit 120.

The diagnosis circuit 114 may execute other diagnostic processing. For example, the diagnosis circuit 114 may calculate RMS values of the reference data and the diagnosis target data, and compare a difference between the two RMS values with a predetermined threshold value to diagnose the state of the object in the second period. For example, the diagnosis circuit 114 may calculate two frequency spectra by performing fast Fourier transform on the reference data and the diagnosis target data, and compare a difference between peak frequencies or peak intensities with predetermined threshold values to diagnose the state of the object in the second period. For example, when there are a plurality of detection axes of the physical quantity sensor 200, the diagnosis circuit 114 may generate reference data and diagnosis target data for each detection axis, calculate a Lissajous' figure of a plurality of pieces of reference data and a Lissajous' figure of a plurality of pieces of diagnosis target data, and diagnose the state of the object in the second period based on a difference between the two Lissajous' figures.

The storage circuit 120 includes a ROM (not shown) and a RAM (not shown). ROM is an abbreviation for read only memory, and RAM is an abbreviation for random access memory. The ROM stores various programs such as the diagnosis program 121 and predetermined data. The RAM stores data generated by the processing circuit 110. The RAM is also used as a work area of the processing circuit 110, and stores programs and data read from the ROM, data input from the operation unit 130, and data temporarily generated by the processing circuit 110.

The operation unit 130 is an input device implemented by operation keys, button switches, and the like, and outputs, to the processing circuit 110, an operation signal corresponding to an operation by a user.

The display unit 140 is a display device implemented by an LCD or the like, and displays various types of information based on display signals output from the processing circuit 110. LCD is an abbreviation for liquid crystal display. The display unit 140 may be provided with a touch panel which functions as the operation unit 130. For example, the display unit 140 may display, based on the display signals output from the processing circuit 110, a screen including at least a part of the first measurement data, a plurality of pieces of first period unit data, the reference data, the second measurement data, the diagnosis target data, the diagnosis result information, and the Lissajous' figure.

The sound output unit 150 is implemented by a speaker or the like, and generates various sounds based on sound signals output from the processing circuit 110. For example, the sound output unit 150 may generate, based on the sound signals output from the processing circuit 110, sounds indicating start or finish of the diagnostic processing.

The communication unit 160 executes various types of control for establishing data communication between the processing circuit 110 and the external device. For example, the communication unit 160 may transmit, to the external device, information including at least a part of the first measurement data, the plurality of pieces of first period unit data, the reference data, the second measurement data, the diagnosis target data, the diagnosis result information, and the Lissajous' figure. The external device may display at least a part of the received information on a display unit (not shown).

At least a part of the first measurement data acquisition circuit 111, the reference data generation circuit 112, the second measurement data acquisition circuit 113, and the diagnosis circuit 114 may be implemented by dedicated hardware. The diagnostic device 100 may be a single device or may include a plurality of devices. For example, the physical quantity sensor 200 and the analog front end 210 may be in a first device, and the processing circuit 110, the storage circuit 120, the operation unit 130, the display unit 140, the sound output unit 150, and the communication unit 160 may be in a second device separate from the first device. For example, the processing circuit 110 and the storage circuit 120 may be implemented by a device such as a cloud server, and the device may generate information such as a plurality of pieces of first period unit data, reference data, diagnosis target data, diagnosis result information, and a Lissajous' figure, and transmit the generated information via a communication line to a terminal including the operation unit 130, the display unit 140, the sound output unit 150, and the communication unit 160.

### 1-1-3. Operation and Effect

In the diagnostic method of the first embodiment described above, the diagnostic device 100 acquires the first measurement data based on the physical quantity generated by the object repeating the predetermined operation pattern in the first period, and generates the reference data by executing the synchronization processing on the plurality of pieces of first period unit data extracted from the first measurement data and calculating the representative value of the plurality of pieces of first period unit data. Therefore, according to the diagnostic method of the first embodiment, the diagnostic device 100 can improve reliability of the diagnosis by diagnosing the state of the object based on highly accurate reference data with reduced variation in the plurality of pieces of first period unit data. In particular, by calculating an average value of the plurality of pieces of first period unit data subjected to the synchronization processing, the diagnostic device 100 can generate highly accurate reference data with reduced variation in the plurality of pieces of first period unit data and reduced high frequency noise, and thus can further improve the reliability of the diagnosis.

In the diagnostic method of the first embodiment, the synchronization processing on the plurality of pieces of first period unit data is processing of aligning timings so that a difference between predetermined data and the other pieces of data in the plurality of pieces of first period unit data is minimized, and thus a calculation load of the synchronization processing is large, and the plurality of pieces of first period unit data are accurately synchronized. Therefore, according to the diagnostic method of the first embodiment, accuracy of the reference data can be improved, and reliability of state diagnosis of the object can be improved.

In the diagnostic method of the first embodiment, the diagnostic device 100 acquires the second measurement data based on the physical quantity generated by the object repeating the predetermined operation pattern in the second period, executes the synchronization processing between the reference data and the diagnosis target data extracted from the second measurement data, and diagnoses the state of the object based on a difference between the reference data and the diagnosis target data subjected to the synchronization processing. Therefore, according to this diagnostic method, regardless of a type of the object or a type of the predetermined operation pattern repeatedly executed by the object, the larger the state change of the object between the first period and the second period, the larger the difference between the reference data and the diagnosis target data, so that it is possible to implement the diagnosis with high versatility and convenience based on the difference.

### 1-2. Second Embodiment

Hereinafter, in a second embodiment, similar components as those in the first embodiment will be denoted by the same reference signs, description overlapping with that in the first embodiment is omitted or simplified, and contents different from those in the first embodiment will be mainly described.

Since a flowchart showing a procedure of a diagnostic method of the second embodiment is similar to that in FIG. 1, an illustration thereof is omitted. In the diagnostic method of the second embodiment, processing of the first measurement data acquisition step S1 and processing of the second measurement data acquisition step S4 are similar to those in the first embodiment. In the diagnostic method of the second embodiment, a method of the synchronization processing in step S23 of the reference data generation step S2 and a method of the synchronization processing in step S52 of the diagnosis step S5 are different from those in the first embodiment.

In the diagnostic method of the second embodiment, the synchronization processing on the plurality of pieces of first period unit data in step S23 of the reference data generation step S2 is processing in which a timing at which an amplitude of predetermined data in the plurality of pieces of first period unit data is maximized matches timings at which amplitudes of the other pieces of data in the plurality of pieces of first period unit data are maximized. For example, the diagnostic device 100 executes synchronization processing of aligning the other pieces of data with the predetermined data by shifting samples of the other pieces of data by the integer j so that the timing at which the amplitude of the predetermined data is maximized matches the timings at which the amplitudes of the other pieces of data are maximized.

FIG. 12 is a diagram showing a part of the first measurement data acquired in the first measurement data acquisition step S1. The first measurement data shown in FIG. 12 is a part of velocity data based on a time-series signal output from a velocity sensor which is the physical quantity sensor when the motor which is the object repeats a predetermined operation pattern in the first period including a first operation, stop, a second operation, and stop. As shown in FIG. 12, the diagnostic device 100 extracts, in step S21 of the reference data generation step S2, from the first measurement data, data obtained when the motor executes the first operation, the stop, and the second operation, which are a part of the predetermined operation pattern, at an n-th time, as n-th first period unit data.

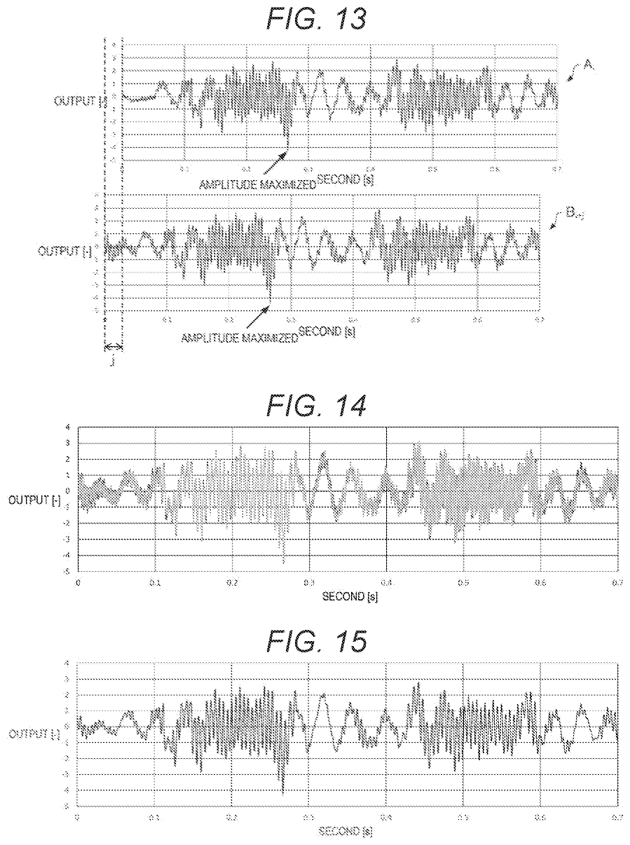

FIGS. 13 and 14 are diagrams showing the synchronization processing between first first period unit data in FIG. 12 and second first period unit data with the first first period unit data as the predetermined data in step S23 of the reference data generation step S2. FIG. 13 is a diagram in which a sample of the second first period unit data is shifted by j with respect to the first first period unit data and is aligned with the first first period unit data. In FIG. 13, when an i-th sample of the first first period unit data is Δⱼ and an i-th sample of the second first period unit data is Bᵢ, the sample Aᵢ and a sample Bᵢ₊ⱼ correspond to each other at the same timing. At this time, determining the integer j so that a timing at which an amplitude of the first first period unit data is maximized matches a timing at which an amplitude of the second first period unit data is maximized corresponds to synchronization processing between the first first period unit data and the second first period unit data. A timing at which an amplitude of the first period unit data is maximized is a timing of a maximum value of the first period unit data when the maximum value is larger than an absolute value of a minimum value of the first period unit data, and is a timing of a minimum value of the first period unit data when the maximum value of the first period unit data is smaller than an absolute value of the minimum value. In an example of FIG. 13, the timing at which the amplitude of the first first period unit data is maximized is the timing of the minimum value. Similarly, the timing at which the amplitude of the second first period unit data is maximized is the timing of the minimum value.

The diagnostic device 100 executes, for the second and subsequent n-th first period unit data, the synchronization processing of determining the integer j so that the timing at which the amplitude of the first first period unit data is maximized matches a timing at which an amplitude of the n-th first period unit data is maximized. FIG. 14 is a diagram in which waveforms of a plurality of pieces of first period unit data extracted from the first measurement data and subjected to the synchronization processing are superimposed.

FIG. 15 is a diagram showing a waveform of the reference data generated by calculating, as a representative value of a plurality of pieces of first period unit data subjected to synchronization processing in step S23 of the reference data generation step S2, an average value of the plurality of pieces of first period unit data. The waveform of the reference data in FIG. 15 is an averaged waveform obtained by averaging the waveforms of the plurality of pieces of first period unit data in FIG. 14. High frequency noise is reduced by averaging the waveforms of the plurality of pieces of first period unit data.

Similarly, the synchronization processing between the reference data and the diagnosis target data in step S52 of the diagnosis step S5 is processing in which a timing at which an amplitude of the reference data is maximized matches a timing at which an amplitude of the diagnosis target data is maximized. For example, the diagnostic device 100 executes synchronization processing of aligning the diagnosis target data with the reference data by shifting a sample of the diagnosis target data by the integer j so that the timing at which the amplitude of the reference data is maximized matches the timing at which the amplitude of diagnosis target data is maximized.

For example, the diagnostic device 100 can obtain, by the above Formula (2), the difference Δⱼ between the reference data and the diagnosis target data subjected to the synchronization processing, and when the difference Δⱼ is smaller than a predetermined threshold value, the diagnostic device 100 can diagnose that a difference between the state of the object in the second period and the state of the object in the first period is small, that is, a state change of the object is small. When the difference Δⱼ is larger than the predetermined threshold value, the diagnostic device 100 can diagnose that the difference between the state of the object in the second period and the state of the object in the first period is large, that is, the state change of the object is large. When the first period is a predetermined period in which the object normally operates, the diagnostic device 100 can diagnose that the object in the second period is in a normal state when the difference Δⱼ is smaller than the predetermined threshold value, and can diagnose that the object in the second period is in an abnormal state when the difference Δⱼ is larger than the predetermined threshold value.

In step S23 of FIG. 2, the diagnostic device 100 may diagnose the state of the object in the second period by setting, as the reference value ref{min{Δⱼ}}, the minimum value min{Δⱼ} of the difference between the predetermined data and any one of the other pieces of data in the plurality of pieces of first period unit data, and by comparing, with the predetermined threshold value, the standard value std{min{Δⱼ}} obtained by dividing the minimum value min{Δⱼ} of the difference Δⱼ between the reference data and the diagnosis target data by the reference value ref{min{Δⱼ}}. In this way, even if the magnitude of the minimum value min{Δⱼ} is different depending on the characteristics of the object and the installation location of the physical quantity sensor, the magnitude of the standard value std{min{Δⱼ}} hardly changes. Therefore, the constant threshold value can be used for the diagnosis regardless of the characteristics of the object and the installation location of the physical quantity sensor. The diagnostic device 100 may calculate, as the reference value ref{min{Δⱼ}}, the average value of the minimum values min{Δⱼ} of the differences between predetermined data and the other pieces of data in the plurality of pieces of first period unit data.

A configuration example of the diagnostic device 100 which executes the diagnostic method of the second embodiment is similar to that of FIG. 11, and thus an illustration thereof is omitted. In the second embodiment, processing executed by the reference data generation circuit 112 and processing executed by the diagnosis circuit 114 are different from those in the first embodiment.

The reference data generation circuit 112 generates reference data based on the first measurement data acquired by the first measurement data acquisition circuit 111. Specifically, the reference data generation circuit 112 extracts, from the first measurement data, a plurality of pieces of first period unit data corresponding to at least a part of the predetermined operation pattern repeated by the object in the first period, executes synchronization processing on the extracted plurality of pieces of first period unit data, and calculates a representative value of the plurality of pieces of first period unit data subjected to the synchronization processing to generate the reference data. The synchronization processing is processing in which a timing at which an amplitude of predetermined data in the plurality of pieces of first period unit data is maximized matches timings at which amplitudes of the other pieces of data in the plurality of pieces of first period unit data are maximized. For example, the reference data generation circuit 112 executes synchronization processing of aligning the other pieces of data with the predetermined data by shifting samples of the other pieces of data by the integer j so that the timing at which the amplitude of the predetermined data is maximized matches the timings at which the amplitudes of the other pieces of data are maximized. The representative value is, for example, an average value, or a median value. The reference data generation circuit 112 may display, on the display unit 140, the extracted plurality of pieces of first period unit data. That is, the reference data generation circuit 112 executes the reference data generation step S2 in FIG. 1, specifically, steps S21, S22, and S23 in FIG. 2. The reference data generated by the reference data generation circuit 112 is stored in the storage circuit 120.

The diagnosis circuit 114 diagnoses the state of the object based on the reference data generated by the reference data generation circuit 112 and the second measurement data acquired by the second measurement data acquisition circuit 113. The diagnosis circuit 114 may diagnose, assuming that the object is in a normal state in the first period, whether the object is in a normal state or in an abnormal state in the second period. The diagnostic device 100 may diagnose how much the object changes with the passage of time from the first period to the second period. For example, the diagnosis circuit 114 may extract, from the second measurement data, diagnosis target data corresponding to at least a part of a predetermined operation pattern repeated by the object in the second period, execute synchronization processing between the reference data and the diagnosis target data, and diagnose the state of the object based on a difference between the reference data and the diagnosis target data subjected to the synchronization processing. The synchronization processing is processing in which a timing at which an amplitude of the reference data is maximized matches a timing at which an amplitude of the diagnosis target data is maximized. For example, the diagnosis circuit 114 executes synchronization processing of aligning the diagnosis target data with the reference data by shifting a sample of the diagnosis target data by the integer j so that the timing at which the amplitude of the reference data is maximized matches the timing at which the amplitude of diagnosis target data is maximized.

For example, the diagnosis circuit 114 can obtain, by the above Formula (2), the difference Δⱼ between the reference data and the diagnosis target data subjected to the synchronization processing, and when the difference Δⱼ is smaller than a predetermined threshold value, the diagnosis circuit 114 can diagnose that a difference between the state of the object in the second period and the state of the object in the first period is small, that is, a state change of the object is small. When the difference Δⱼ is larger than the predetermined threshold value, the diagnosis circuit 114 can diagnose that the difference between the state of the object in the second period and the state of the object in the first period is large, that is, the state change of the object is large. When the first period is a predetermined period in which the object normally operates, the diagnosis circuit 114 can diagnose that the object in the second period is in a normal state when the difference Δⱼ is smaller than the predetermined threshold value, and can diagnose that the object in the second period is in an abnormal state when the difference Δⱼ is larger than the predetermined threshold value. That is, the diagnosis circuit 114 executes the diagnosis step S5 in FIG. 1, specifically, steps S51 and S52 in FIG. 9. Diagnosis result information of the diagnosis circuit 114 is stored in the storage circuit 120.

Since other configurations of the diagnostic device 100 according to the second embodiment are similar to those of the first embodiment, the description thereof is omitted.

As described above, according to the diagnostic method of the second embodiment, since the synchronization processing on the plurality of pieces of first period unit data is processing in which a timing at which an amplitude of predetermined data in the plurality of pieces of first period unit data is maximized matches timings at which amplitudes of the other pieces of data in the plurality of pieces of first period unit data are maximized, the calculation load of the synchronization processing is small. According to the diagnostic method of the second embodiment, when the object repeats the operation pattern such that an amplitude of a detected physical quantity is maximized at a predetermined timing, a plurality of pieces of first period unit data are accurately synchronized with each other, so that the accuracy of the reference data can be improved, and the reliability of the state diagnosis of the object can be improved.

In addition, according to the diagnostic method of the second embodiment, similar effects as those of the diagnostic method of the first embodiment can be obtained.

### 1-3. Third Embodiment

Hereinafter, in a third embodiment, similar components as those in the first embodiment or in the second embodiment will be denoted by the same reference signs, description overlapping with that in the first embodiment or the second embodiment is omitted or simplified, and contents different from those in the first embodiment or in the second embodiment will be mainly described.

Since a flowchart showing a procedure of a diagnostic method of the third embodiment is similar to that in FIG. 1, an illustration thereof is omitted. In the diagnostic method of the third embodiment, processing of the first measurement data acquisition step S1 and processing of the second measurement data acquisition step S4 are similar to those in the first embodiment or in the second embodiment. In the diagnostic method of the third embodiment, processing of the diagnosis step S5 is different from that in the first embodiment and in the second embodiment.

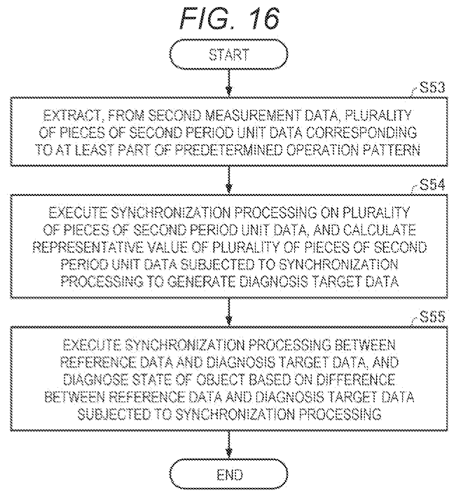

FIG. 16 is a flowchart showing an example of a procedure of the diagnosis step S5 in the diagnostic method of the third embodiment. As shown in FIG. 16, first, in step S53, the diagnostic device 100 extracts, from the second measurement data acquired in the second measurement data acquisition step S4, a plurality of pieces of second period unit data corresponding to at least a part of the predetermined operation pattern repeated by the object in the second period. For example, if the predetermined operation pattern is a pattern in which the object executes one type of operation and then stops the operation, the plurality of pieces of second period unit data may be data corresponding to the operation. For example, if the predetermined operation pattern is a pattern in which each time the object executes each of a plurality of different types of operations, the operation is stopped, the plurality of pieces of second period unit data may be data corresponding to the plurality of operations.

Processing of step S53 is the same as the processing of step S21 in FIG. 2 in which the first measurement data is replaced with the second measurement data and a plurality of pieces of first period unit data are replaced with a plurality of pieces of second period unit data.

Next, in step S54, the diagnostic device 100 executes synchronization processing on the plurality of pieces of second period unit data extracted in step S53, and calculates a representative value of the plurality of pieces of second period unit data subjected to the synchronization processing to generate diagnosis target data. Similar as in the first embodiment, the synchronization processing may be processing of aligning timings so that a difference between predetermined data and the other pieces of data in the plurality of pieces of second period unit data is minimized. Specifically, when an i-th sample of the predetermined data is Eᵢ and an i-th sample of any other pieces of data is Fᵢ, a difference Δⱼ between the predetermined data and the other pieces of data obtained by shifting samples of the other pieces of data by j is calculated by Formula (3) similar to Formula (1) described above. In Formula (3), when −jₘₐₓ≤j≤jₘₐₓ and the number of samples of the predetermined data and the number of samples of the other pieces of data are M, mₛ≥jₘₐₓ and m_{f}≥M−jₘₐₓ.

$${Δ}_{j} = {\sum }_{i = {m}_{s}}^{{m}_{f}} \vert {E}_{i} - {F}_{i + j} \vert \qquad ( 3 )$$

Alternatively, similar as in the second embodiment, the synchronization processing may be processing in which a timing at which an amplitude of predetermined data in the plurality of pieces of second period unit data is maximized matches timings at which amplitudes of the other pieces of data in the plurality of pieces of second period unit data are maximized.

The representative value is, for example, an average value, or a median value. For example, when the representative value is the average value, the diagnosis target data in which high frequency noise is reduced is generated by averaging waveforms of the plurality of pieces of second period unit data.

Processing of step S54 is the same as processing of step S23 in FIG. 2 in which a plurality of pieces of first period unit data are replaced with a plurality of pieces of second period unit data and the reference data is replaced with the diagnosis target data.

In step S55, the diagnostic device 100 executes synchronization processing between the reference data generated in the reference data generation step S2 and the diagnosis target data generated in step S54, and diagnoses the state of the object based on a difference between the reference data and the diagnosis target data subjected to the synchronization processing. Similar as in the first embodiment, the synchronization processing may be processing of aligning timings so that the difference between the reference data and the diagnosis target data is minimized. Alternatively, similar as in the second embodiment, the synchronization processing may be processing in which a timing at which an amplitude of the reference data is maximized matches a timing at which an amplitude of the diagnosis target data is maximized.

A configuration example of the diagnostic device 100 which executes the diagnostic method of the third embodiment is similar to that of FIG. 11, and thus an illustration thereof is omitted. In the third embodiment, the processing executed by the diagnosis circuit 114 is different from that in the first embodiment and in the second embodiment.

The diagnosis circuit 114 diagnoses the state of the object based on the reference data generated by the reference data generation circuit 112 and the second measurement data acquired by the second measurement data acquisition circuit 113. Specifically, first, the diagnosis circuit 114 extracts, from the second measurement data acquired by the second measurement data acquisition circuit 113, a plurality of pieces of second period unit data corresponding to at least a part of the predetermined operation pattern repeated by the object in the second period. Next, the diagnosis circuit 114 executes synchronization processing on the extracted plurality of pieces of second period unit data, and calculates a representative value of the plurality of pieces of second period unit data subjected to the synchronization processing to generate diagnosis target data. The synchronization processing may be processing of aligning timings so that a difference between the predetermined data and the other pieces of data in the plurality of pieces of second period unit data is minimized, or may be processing in which a timing at which an amplitude of the predetermined data in the plurality of pieces of second period unit data is maximized matches timings at which amplitudes of the other pieces of data in the plurality of pieces of second period unit data are maximized. The representative value is, for example, an average value, or a median value. The diagnosis circuit 114 executes synchronization processing between the reference data and the diagnosis target data, and diagnoses a state of the object based on a difference between the reference data and the diagnosis target data subjected to the synchronization processing. The synchronization processing may be processing of aligning timings so that a difference between the reference data and the diagnosis target data is minimized, or may be processing in which a timing at which an amplitude of the reference data is maximized matches a timing at which an amplitude of the diagnosis target data is maximized. That is, the diagnosis circuit 114 executes the diagnosis step S5 in FIG. 1, specifically, steps S53, S54, and S55 in FIG. 16. Diagnosis result information of the diagnosis circuit 114 is stored in the storage circuit 120.

Since other configurations of the diagnostic device 100 according to the third embodiment are similar to those of the first embodiment or the second embodiment, the description thereof is omitted.

In the diagnostic method of the third embodiment as described above, the diagnostic device 100 acquires the second measurement data based on the physical quantity generated by the object repeating the predetermined operation pattern in the second period, and generates the diagnosis target data by executing the synchronization processing on the plurality of pieces of second period unit data extracted from the second measurement data and calculating the representative value of the plurality of pieces of second period unit data. Therefore, according to the diagnostic method of the third embodiment, the diagnostic device 100 can improve reliability of the diagnosis by diagnosing the state of the object based on highly accurate diagnosis target data with reduced variation in the plurality of pieces of second period unit data. In particular, by calculating an average value of the plurality of pieces of second period unit data subjected to the synchronization processing, the diagnostic device 100 can generate highly accurate diagnosis target data with reduced variation in the plurality of pieces of second period unit data and reduced high frequency noise, and thus can further improve the reliability of diagnosis.

In addition, according to the diagnostic method of the third embodiment, similar effects as those of the diagnostic method of the first embodiment or the second embodiment can be obtained.

### 1-4. Fourth Embodiment

Hereinafter, in a fourth embodiment, similar components as those in any one of the first embodiment to the third embodiment are denoted by the same reference signs, description overlapping with that in any one of the first embodiment to the third embodiment is omitted or simplified, and contents different from those in any one of the first embodiment to the third embodiment will be mainly described.

In the diagnostic methods of the first embodiment to the third embodiment, when the predetermined operation pattern is repeated in which each time the object executes each of a plurality of different types of operations in the first period, the operation is stopped, if there is variation in a stop time, the accuracy of the reference data may decrease. For example, in the first measurement data shown in FIG. 3 described above, if there is variation in the stop time between the first operation and the second operation, at least one of a timing of a sample group corresponding to the first operation and a timing of a sample group corresponding to the second operation varies in the plurality of synchronized first period unit data, and thus accuracy of the calculated representative value decreases. Therefore, in a diagnostic method of the fourth embodiment, the diagnostic device 100 separately executes, for each of a plurality of operations in a predetermined operation pattern, generation of a plurality of pieces of first period unit data, synchronization processing, and generation of reference data. Accordingly, even if the stop time varies, the accuracy of the reference data corresponding to each operation does not decrease.

Since a flowchart showing a procedure of the diagnostic method of the fourth embodiment is similar to that in FIG. 1, an illustration thereof is omitted. In the diagnostic method of the fourth embodiment, processing of the first measurement data acquisition step S1 and processing of the second measurement data acquisition step S4 are similar to those in the first embodiment to the third embodiment. In the diagnostic method of the fourth embodiment, processing of the reference data generation step S2 and processing of the diagnosis step S5 are different from those in the first embodiment to the third embodiment.

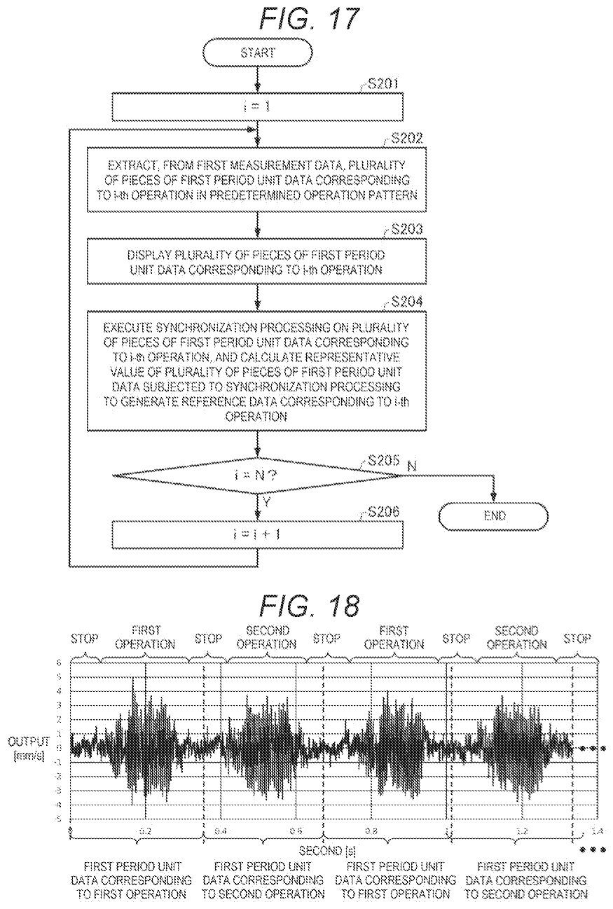

FIG. 17 is a flowchart showing an example of a procedure of the reference data generation step S2 according to the fourth embodiment. FIG. 17 shows an example in which a predetermined operation pattern repeated by the object in the first period is a pattern in which each time the object executes each of a first operation to an N-th operation of different types, the operation is stopped. N is an integer of 2 or more.

As shown in FIG. 17, first, the diagnostic device 100 sets an integer i to 1 in step S201, and extracts, in step S202, from the first measurement data acquired in the first measurement data acquisition step S1, a plurality of pieces of first period unit data corresponding to an i-th operation in the predetermined operation pattern.

Next, in step S203, the diagnostic device 100 displays, on a display unit (not shown), the plurality of pieces of first period unit data corresponding to the i-th operation extracted in step S202.

Next, in step S204, the diagnostic device 100 executes synchronization processing on the plurality of pieces of first period unit data corresponding to the i-th operation extracted in step S202, and calculates a representative value of the plurality of pieces of first period unit data subjected to the synchronization processing to generate reference data corresponding to the i-th operation. The synchronization processing may be processing of aligning timings so that a difference between the predetermined data and the other pieces of data in the plurality of pieces of first period unit data is minimized, or may be processing in which a timing at which an amplitude of the predetermined data in the plurality of pieces of first period unit data is maximized matches timings at which amplitudes of the other pieces of data in the plurality of pieces of first period unit data are maximized. The representative value is, for example, an average value, or a median value.

If the integer i is not N in step S205, the diagnostic device 100 increases the integer i by 1 in step S206 and executes step S202 and the subsequent steps again, and if the integer i is N in step S205, the diagnostic device 100 finishes the processing.

FIG. 18 is a diagram showing an example of a relationship between the first measurement data and a plurality of pieces of first period unit data corresponding to the i-th operation. The first measurement data shown in FIG. 18 is a part of velocity data based on a time-series signal output from a velocity sensor which is the physical quantity sensor when the motor which is the object repeats a predetermined operation pattern including a first operation, stop, a second operation, and stop in the first period. As shown in FIG. 18, the diagnostic device 100 extracts, in step S202, from the first measurement data, data obtained when the motor executes the first operation for an n-th time as n-th first period unit data corresponding to the first operation, and generates, in step S204, reference data corresponding to the first operation. The diagnostic device 100 extracts, in step S202, from the first measurement data, data obtained when the motor executes the second operation for an n-th time as n-th first period unit data corresponding to the second operation, and generates, in step S204, reference data corresponding to the second operation.

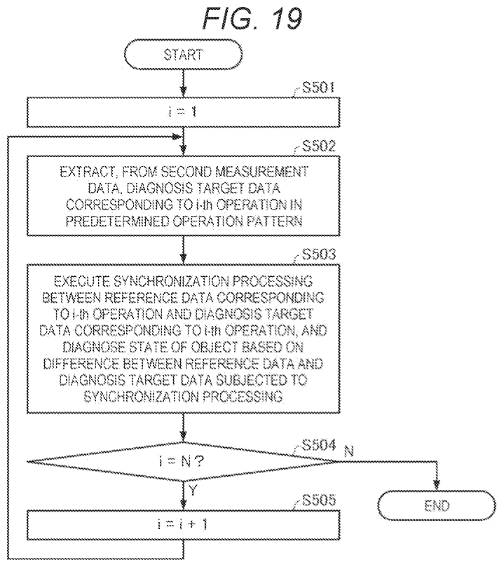

FIG. 19 is a flowchart showing an example of a procedure of the diagnosis step S5 in the fourth embodiment. As shown in FIG. 19, first, the diagnostic device 100 sets the integer i to 1 in step S501, and extracts, in step S502, from the second measurement data acquired in the second measurement data acquisition step S4, diagnosis target data corresponding to an i-th operation in the predetermined operation pattern.

Next, in step S503, the diagnostic device 100 executes synchronization processing between the reference data corresponding to the i-th operation generated in the reference data generation step S2 and the diagnosis target data extracted in step S502, and diagnoses the state of the object based on a difference between the reference data and the diagnosis target data subjected to the synchronization processing. The synchronization processing may be processing of aligning timings so that the difference between the reference data and the diagnosis target data is minimized, or may be processing in which a timing at which an amplitude of the reference data is maximized matches a timing at which an amplitude of the diagnosis target data is maximized.

If the integer i is not N in step S504, the diagnostic device 100 increases the integer i by 1 in step S505 and executes step S502 and the subsequent steps again, and if the integer i is N in step S504, the diagnostic device 100 finishes the processing.

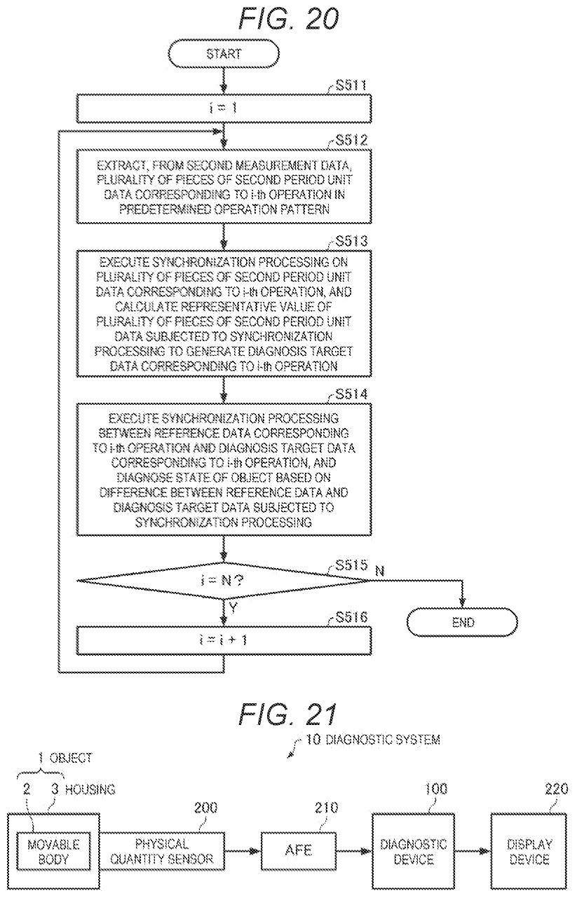

FIG. 20 is a flowchart showing another example of the procedure of the diagnosis step S5 in the diagnostic method of the fourth embodiment. As shown in FIG. 20, first, the diagnostic device 100 sets the integer i to 1 in step S511, and extracts, in step S512, from the second measurement data acquired in the second measurement data acquisition step S4, a plurality of pieces of second period unit data corresponding to an i-th operation in the predetermined operation pattern.

Next, in step S513, the diagnostic device 100 executes synchronization processing on the plurality of pieces of second period unit data corresponding to the i-th operation extracted in step S512, and calculates a representative value of the plurality of pieces of second period unit data subjected to the synchronization processing to generate diagnosis target data corresponding to the i-th operation. The synchronization processing may be processing of aligning timings so that a difference between the predetermined data and the other pieces of data in the plurality of pieces of second period unit data is minimized, or may be processing in which a timing at which an amplitude of the predetermined data in the plurality of pieces of second period unit data is maximized matches timings at which amplitudes of the other pieces of data in the plurality of pieces of second period unit data are maximized. The representative value is, for example, an average value, or a median value.

Next, in step S514, the diagnostic device 100 executes synchronization processing between the reference data corresponding to the i-th operation generated in the reference data generation step S2 and the diagnosis target data corresponding to the i-th operation generated in step S513, and diagnoses the state of the object based on a difference between the reference data and the diagnosis target data subjected to the synchronization processing. The synchronization processing may be processing of aligning timings so that the difference between the reference data and the diagnosis target data is minimized, or may be processing in which a timing at which an amplitude of the reference data is maximized matches a timing at which an amplitude of the diagnosis target data is maximized.

If the integer i is not N in step S515, the diagnostic device 100 increases the integer i by 1 in step S516 and executes step S512 and the subsequent steps again, and if the integer i is N in step S515, the diagnostic device 100 finishes the processing.

A configuration example of the diagnostic device 100 which executes the diagnostic method of the fourth embodiment is similar to that of FIG. 11, and thus an illustration thereof is omitted. In the fourth embodiment, processing executed by the reference data generation circuit 112 and processing executed by the diagnosis circuit 114 are different from those in the first embodiment.

The reference data generation circuit 112 generates, based on the first measurement data acquired by the first measurement data acquisition circuit 111 for each integer i of 1 or more and N or less, reference data corresponding to the i-th operation. N is an integer of 2 or more. Specifically, for each integer i of 1 or more and N or less, the reference data generation circuit 112 extracts, from the first measurement data, a plurality of pieces of first period unit data corresponding to the i-th operation in the predetermined operation pattern repeated by the object in the first period, executes synchronization processing on the extracted plurality of pieces of first period unit data corresponding to the i-th operation, and calculates a representative value of the plurality of pieces of first period unit data subjected to the synchronization processing to generate the reference data corresponding to the i-th operation. The synchronization processing may be processing of aligning timings so that a difference between the predetermined data and the other pieces of data in the plurality of pieces of first period unit data is minimized, or may be processing in which a timing at which an amplitude of the predetermined data in the plurality of pieces of first period unit data is maximized matches timings at which amplitudes of the other pieces of data in the plurality of pieces of first period unit data are maximized. The representative value is, for example, an average value, or a median value. The reference data generation circuit 112 may display, on the display unit 140, the extracted plurality of pieces of first period unit data corresponding to the i-th operation. That is, the reference data generation circuit 112 executes the reference data generation step S2 in FIG. 1, specifically, steps S201 to S206 in FIG. 17. The reference data corresponding to the first operation to the N-th operation generated by the reference data generation circuit 112 is stored in the storage circuit 120.

The diagnosis circuit 114 diagnoses, for each integer i of 1 or more and N or less, the state of the object based on the reference data corresponding to the i-th operation generated by the reference data generation circuit 112 and the second measurement data acquired by the second measurement data acquisition circuit 113. The diagnosis circuit 114 may diagnose, assuming that the object is in a normal state in the first period, whether the object is in a normal state or in an abnormal state in the second period. The diagnostic device 100 may diagnose how much the object changes with the passage of time from the first period to the second period.

For example, the diagnosis circuit 114 may extract, for each integer i of 1 or more and N or less, from the second measurement data, the diagnosis target data corresponding to the i-th operation in the predetermined operation pattern repeated by the object in the second period. For example, for each integer i of 1 or more and N or less, the diagnosis circuit 114 extracts, from the second measurement data, a plurality of pieces of second period unit data corresponding to the i-th operation in the predetermined operation pattern, executes synchronization processing on the extracted plurality of pieces of second period unit data corresponding to the i-th operation, and calculates a representative value of the plurality of pieces of second period unit data subjected to the synchronization processing to generate the diagnosis target data corresponding to the i-th operation. The synchronization processing may be processing of aligning timings so that a difference between the predetermined data and the other pieces of data in the plurality of pieces of second period unit data is minimized, or may be processing in which a timing at which an amplitude of the predetermined data in the plurality of pieces of second period unit data is maximized matches timings at which amplitudes of the other pieces of data in the plurality of pieces of second period unit data are maximized. The representative value is, for example, an average value, or a median value.

The diagnosis circuit 114 executes, for each integer i of 1 or more and N or less, synchronization processing between the reference data corresponding to the i-th operation and the diagnosis target data corresponding to the i-th operation, and diagnoses a state of the object based on a difference between the reference data and the diagnosis target data subjected to the synchronization processing. The synchronization processing may be processing of aligning timings so that the difference between the reference data and the diagnosis target data is minimized, or may be processing in which a timing at which an amplitude of the reference data is maximized matches a timing at which an amplitude of the diagnosis target data is maximized. That is, the diagnosis circuit 114 executes the diagnosis step S5 in FIG. 1, specifically, steps S501 to S505 in FIG. 19 or S511 to S516 in FIG. 20. Diagnosis result information of the diagnosis circuit 114 is stored in the storage circuit 120.

Since other configurations of the diagnostic device 100 according to the fourth embodiment are similar to those of the first embodiment, the description thereof is omitted.

As described above, in the diagnostic method of the fourth embodiment, the predetermined operation pattern repeatedly executed by the object in the first period and the second period is a pattern in which each time the object executes each of a plurality of different types of operations, the operation is stopped. The plurality of pieces of first period unit data extracted by the diagnostic device 100 in step S202 of the reference data generation step S2 are data corresponding to any one of the plurality of operations. The diagnostic device 100 generates, for each integer i of 1 or more and N or less, a plurality of pieces of first period unit data corresponding to the i-th operation by repeating step S202. Since the plurality of pieces of first period unit data corresponding to the i-th operation generated thus do not include samples corresponding to operations other than the i-th operation, even when there is variation in a time at which an operation of the object is stopped before and after the i-th operation, the diagnostic device 100 can accurately generate reference data corresponding to the i-th operation by accurately synchronizing the plurality of pieces of first period unit data corresponding to the i-th operation in step S204. Therefore, according to the diagnostic method of the fourth embodiment, the diagnostic device 100 can improve reliability of the diagnosis by diagnosing the state of the object based on the reference data corresponding to the i-th operation and the diagnosis target data corresponding to the i-th operation.

In addition, according to the diagnostic method of the fourth embodiment, similar effects as those of the diagnostic method of the first embodiment to the third embodiment can be obtained.

### 2. Diagnostic System

Hereinafter, in a diagnostic system according to the present embodiment, similar components as those described in any of the above embodiments are denoted by the same reference signs, the description overlapping with that in any of the above embodiments is omitted or simplified, and contents different from those of any of the above embodiments will be mainly described.

FIG. 21 is a diagram showing a configuration example of the diagnostic system according to the present embodiment. As shown in FIG. 21, a diagnostic system 10 of the present embodiment includes the physical quantity sensor 200, the analog front end 210, the diagnostic device 100, and a display device 220.

An object 1 includes a movable body 2 and a housing 3 housing the movable body 2. The physical quantity sensor 200 is attached to the housing 3, detects a physical quantity generated by the object repeating a predetermined operation pattern in the first period and in the second period, and outputs a signal having a magnitude corresponding to the detected physical quantity. An output signal of the physical quantity sensor 200 is input to the analog front end 210.

The analog front end 210 executes amplification processing, A/D conversion processing, and the like on the output signal of the physical quantity sensor 200, and outputs a digital time-series signal.

The diagnostic device 100 acquires, as the first measurement data, the digital time-series signal output from the analog front end 210 in the first period, and generates reference data based on the acquired first measurement data. The diagnostic device 100 acquires, as the second measurement data, the digital time-series signal output from the analog front end 210 in the second period. The diagnostic device 100 diagnoses the state of the object based on the reference data and the second measurement data, and displays diagnosis result information on the display device 220. As the diagnostic device 100, for example, any one of the diagnostic devices 100 of the first embodiment to the fourth embodiment described above can be applied.

According to the diagnostic system 10 of the present embodiment, it is possible to improve reliability of state diagnosis of the object 1 by the diagnostic device 100.

The present disclosure is not limited to the present embodiment, and various modifications can be made within the scope of the gist of the present disclosure.

The above embodiments and modifications are merely examples, and the present disclosure is not limited thereto. For example, it is also possible to appropriately combine the embodiment and the modification.

The present disclosure includes a configuration substantially the same as the configuration described in the embodiment, for example, a configuration having the same function, method and result, or a configuration having the same purpose and effect. The present disclosure includes a configuration obtained by replacing a non-essential portion of the configuration described in the embodiment. The present disclosure includes a configuration having the same function and effect as the configuration described in the embodiment, or a configuration capable of achieving the same purpose. The present disclosure includes a configuration in which a known technique is added to the configuration described in the embodiment.

The following contents are derived from the embodiments and modifications described above.

A diagnostic method according to one aspect includes:

a first measurement data acquisition step of acquiring first measurement data based on a time-series signal obtained by a physical quantity sensor detecting a physical quantity generated by an object repeating a predetermined operation pattern in a first period;

a reference data generation step of generating reference data based on the first measurement data;

a second measurement data acquisition step of acquiring second measurement data based on a time-series signal obtained by the physical quantity sensor detecting a physical quantity generated by the object repeating the predetermined operation pattern in a second period; and

a diagnosis step of diagnosing a state of the object based on the reference data and the second measurement data, in which

the reference data generation step includes

extracting, from the first measurement data, a plurality of pieces of first period unit data corresponding to at least a part of the predetermined operation pattern, and

generating the reference data by executing synchronization processing on the plurality of pieces of first period unit data and calculating a representative value of the plurality of pieces of first period unit data subjected to the synchronization processing.

According to the diagnostic method, by acquiring the first measurement data based on the physical quantity generated by the object repeating the predetermined operation pattern in the first period, and executing the synchronization processing on the plurality of pieces of first period unit data extracted from the first measurement data and calculating the representative value of the plurality of pieces of first period unit data, highly accurate reference data can be generated in which the variation in the plurality of pieces of first period unit data is reduced, and thus the reliability of the state diagnosis of the object can be improved.

In the diagnostic method according to the one aspect,

the reference data generation step may include

displaying waveforms of the plurality of pieces of first period unit data.

In the diagnostic method according to the one aspect,

the synchronization processing may be processing of aligning timings so that a difference between predetermined data and the other pieces of data in the plurality of pieces of first period unit data is minimized.

According to this diagnostic method, although the calculation load of the synchronization processing is large, since the plurality of pieces of first period unit data are accurately synchronized, the accuracy of the reference data can be improved, and the reliability of the state diagnosis of the object can be improved.

In the diagnostic method according to the one aspect,

the synchronization processing may be processing in which a timing at which an amplitude of predetermined data in the plurality of pieces of first period unit data is maximized matches timings at which amplitudes of the other pieces of data in the plurality of pieces of first period unit data are maximized.

According to this diagnostic method, the calculation load of the synchronization processing on the plurality of pieces of first period unit data is small. According to the diagnostic method, when the object repeats the operation pattern such that the amplitude of the detected physical quantity is maximized at the predetermined timing, the plurality of pieces of first period unit data are accurately synchronized with each other, so that the accuracy of the reference data can be improved, and the reliability of the state diagnosis of the object can be improved.

In the diagnostic method according to the one aspect,

the diagnosis step may include

extracting, from the second measurement data, diagnosis target data corresponding to at least a part of the predetermined operation pattern, and

executing synchronization processing between the reference data and the diagnosis target data, and diagnosing a state of the object based on a difference between the reference data and the diagnosis target data subjected to the synchronization processing.

According to this diagnostic method, regardless of a type of the object or a type of the predetermined operation pattern repeatedly executed by the object, the larger the state change of the object between the first period and the second period, the larger the difference between the reference data and the diagnosis target data, so that it is possible to implement the diagnosis with high versatility and convenience based on the difference.

In the diagnostic method according to the one aspect,

the diagnosis step may include

extracting, from the second measurement data, a plurality of pieces of second period unit data corresponding to at least a part of the predetermined operation pattern,

generating diagnosis target data by executing synchronization processing on the plurality of pieces of second period unit data and calculating a representative value of the plurality of pieces of second period unit data subjected to the synchronization processing, and

executing synchronization processing between the reference data and the diagnosis target data, and diagnosing a state of the object based on a difference between the reference data and the diagnosis target data subjected to the synchronization processing.

According to the diagnostic method, by acquiring the second measurement data based on the physical quantity generated by the object repeating the predetermined operation pattern in the second period, and executing the synchronization processing on the plurality of pieces of second period unit data extracted from the second measurement data and calculating the representative value of the plurality of pieces of second period unit data, highly accurate diagnosis target data can be generated in which the variation in the plurality of pieces of second period unit data is reduced, and thus reliability of the state diagnosis of the object can be improved.

In the diagnostic method according to the one aspect,

the representative value may be an average value.

According to this diagnostic method, by executing the synchronization processing on the plurality of pieces of first period unit data extracted from the first measurement data and calculating the average value of the plurality of pieces of first period unit data, highly accurate reference data can be generated with reduced variation in the plurality of pieces of first period unit data and reduced high frequency noise, and the reliability of the state diagnosis of the object can be improved.

In the diagnostic method according to the one aspect,

the physical quantity sensor may be an inertial sensor.

In the diagnostic method according to the one aspect,

the predetermined operation pattern may be a pattern in which each time the object executes each of a plurality of different types of operations, the operation is stopped, and

the plurality of pieces of first period unit data may be data corresponding to any one of the plurality of operations.

According to this diagnostic method, even if there is variation in the time at which the object stops the operation between the first operation and the second operation among the plurality of operations, it is possible to accurately synchronize the plurality of pieces of first period unit data corresponding to the first operation or the second operation to generate the diagnosis target data with high accuracy, and thus the reliability of the state diagnosis of the object can be improved.

A diagnostic device according to one aspect includes:

a first measurement data acquisition circuit configured to acquire first measurement data based on a time-series signal obtained by a physical quantity sensor detecting a physical quantity generated by an object repeating a predetermined operation pattern in a first period;

a reference data generation circuit configured to generate reference data based on the first measurement data;

a second measurement data acquisition circuit configured to acquire second measurement data based on a time-series signal obtained by the physical quantity sensor detecting a physical quantity generated by the object repeating the predetermined operation pattern in a second period; and

a diagnosis circuit configured to diagnose a state of the object based on the reference data and the second measurement data, in which

the reference data generation circuit

extracts, from the first measurement data, a plurality of pieces of first period unit data corresponding to at least a part of the predetermined operation pattern, executes synchronization processing on the plurality of pieces of first period unit data, and calculates a representative value of the plurality of pieces of first period unit data subjected to the synchronization processing to generate the reference data.

According to the diagnostic device, by acquiring the first measurement data based on the physical quantity generated by the object repeating the predetermined operation pattern in the first period, and executing the synchronization processing on the plurality of pieces of first period unit data extracted from the first measurement data and calculating the representative value of the plurality of pieces of first period unit data, highly accurate reference data can be generated in which the variation in the plurality of pieces of first period unit data is reduced, and thus the reliability of the state diagnosis of the object can be improved.

A diagnostic system according to one aspect includes:

the diagnostic device according to the one aspect; and

the physical quantity sensor attached to the object.

According to the diagnostic system, the diagnostic device acquires the first measurement data based on the physical quantity generated by the object repeating the predetermined operation pattern in the first period, and executes the synchronization processing on the plurality of pieces of first period unit data extracted from the first measurement data and calculates the representative value of the plurality of pieces of first period unit data, so that highly accurate reference data can be generated in which the variation in the plurality of pieces of first period unit data is reduced, and thus the reliability of the state diagnosis of the object can be improved.

What is claimed is:

1. A diagnostic method comprising:
a first measurement data acquisition step of acquiring first measurement data based on a time-series signal obtained by a physical quantity sensor detecting a physical quantity generated by an object repeating a predetermined operation pattern in a first period;
a reference data generation step of generating reference data based on the first measurement data;
a second measurement data acquisition step of acquiring second measurement data based on a time-series signal obtained by the physical quantity sensor detecting a physical quantity generated by the object repeating the predetermined operation pattern in a second period; and
a diagnosis step of diagnosing a state of the object based on the reference data and the second measurement data, wherein
the reference data generation step includes
extracting, from the first measurement data, a plurality of pieces of first period unit data corresponding to at least a part of the predetermined operation pattern, and
generating the reference data by executing synchronization processing on the plurality of pieces of first period unit data and calculating a representative value of the plurality of pieces of first period unit data subjected to the synchronization processing.

2. The diagnostic method according to claim 1, wherein
the reference data generation step includes
displaying waveforms of the plurality of pieces of first period unit data.

3. The diagnostic method according to claim 1, wherein
the synchronization processing is processing of aligning timings so that a difference between predetermined data and the other pieces of data in the plurality of pieces of first period unit data is minimized.

4. The diagnostic method according to claim 1, wherein
the synchronization processing is processing in which a timing at which an amplitude of predetermined data in the plurality of pieces of first period unit data is maximized matches timings at which amplitudes of the other pieces of data in the plurality of pieces of first period unit data are maximized.

5. The diagnostic method according to claim 1, wherein
the diagnosis step includes
extracting, from the second measurement data, diagnosis target data corresponding to at least a part of the predetermined operation pattern, and
executing synchronization processing between the reference data and the diagnosis target data, and diagnosing a state of the object based on a difference between the reference data and the diagnosis target data subjected to the synchronization processing.

6. The diagnostic method according to claim 1, wherein
the diagnosis step includes
extracting, from the second measurement data, a plurality of pieces of second period unit data corresponding to at least a part of the predetermined operation pattern,
generating diagnosis target data by executing synchronization processing on the plurality of pieces of second period unit data and calculating a representative value of the plurality of pieces of second period unit data subjected to the synchronization processing, and
executing synchronization processing between the reference data and the diagnosis target data, and diagnosing a state of the object based on a difference between the reference data and the diagnosis target data subjected to the synchronization processing.

7. The diagnostic method according to claim 1, wherein
the representative value is an average value.

8. The diagnostic method according to claim 1, wherein
the physical quantity sensor is an inertial sensor.

9. The diagnostic method according to claim 1, wherein
the predetermined operation pattern is a pattern in which each time the object executes each of a plurality of different types of operations, the operation is stopped, and
the plurality of pieces of first period unit data are data corresponding to any one of the plurality of operations.

10. A diagnostic device comprising:
a first measurement data acquisition circuit configured to acquire first measurement data based on a time-series signal obtained by a physical quantity sensor detecting a physical quantity generated by an object repeating a predetermined operation pattern in a first period;
a reference data generation circuit configured to generate reference data based on the first measurement data;
a second measurement data acquisition circuit configured to acquire second measurement data based on a time-series signal obtained by the physical quantity sensor detecting a physical quantity generated by the object repeating the predetermined operation pattern in a second period; and
a diagnosis circuit configured to diagnose a state of the object based on the reference data and the second measurement data, wherein
the reference data generation circuit
extracts, from the first measurement data, a plurality of pieces of first period unit data corresponding to at least a part of the predetermined operation pattern, executes synchronization processing on the plurality of pieces of first period unit data, and calculates a representative value of the plurality of pieces of first period unit data subjected to the synchronization processing to generate the reference data.

11. A diagnostic system comprising:
the diagnostic device according to claim 10; and
the physical quantity sensor attached to the object.
